(19) United States
(12) Patent Application Publication
(10) Pub. No.: US 2009/0158209 A1
(43) Pub. Date: Jun. 18, 2009

(54) SYSTEM AND METHOD FOR SELECTING OBJECTS FROM A USER INTERFACE OF AN ELECTRONIC DEVICE

(75) Inventors: YU-CHUN CHEN, Tu-Cheng (TW); CHIEN-LUNG CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/143,845

(22) Filed: Jun. 23, 2008

(30) Foreign Application Priority Data
Dec. 14, 2007 (CN) 200710203072.6

(51) Int. Cl. G06F 3/048

(52) U.S. Cl. 715/810

(57) ABSTRACT

An exemplary method for selecting objects from a user interface of an electronic device includes the following steps of: creating a two dimensional coordinate system to position a number of objects in the user interface; acquiring a 2D coordinate value of each of number of the objects; setting an index corresponding to each of the number of objects; creating a two dimensional array to store all indexes; identifying an input 2D coordinate value of a target object; confirming a position in the two dimensional array according to the input 2D coordinate value; acquiring a corresponding index from the two dimensional array according to the confirmed position; and acquiring the target object from the user interface according to the corresponding index.

### BACKGROUND

1. Field of the Invention

The present invention relates to systems and methods for managing a user interface, and particularly to a system and method for selecting objects from a user interface of an electronic device.

2. Description of related art

Electronic devices are continuously integrated with improved and/or increased functionalities. However, as more and more functions are provided in the electronic devices, selecting a desired function becomes difficult. Generally, if one target icon in a user interface (UI) of the electronic device needs to be selected from a number of icons, a directional key has to be repeatedly pressed until a cursor in the UI has moved above (highlights) the target icon.

However, when an icon was erroneously selected, the process must be repeated. Thus time is wasted, especially when many icons are included in the UI.

Accordingly, what is needed is a system and method for quickly and accurately selecting objects from the UI of an electronic device.

### SUMMARY

An exemplary method for selecting objects from a user interface of an electronic device is provided. The method includes the following steps of: creating a two dimensional coordinate system to position a number of objects in the user interface; acquiring a 2D coordinate value of each of the number of the objects; setting an index corresponding to each of the number of objects; creating a two dimensional array to store all indexes; identifying an input 2D coordinate value of a target object; confirming a position in the two dimensional array according to the input 2D coordinate value; acquiring a corresponding index from the two dimensional array according to the confirmed position; and acquiring the target object from the user interface according to the corresponding index.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a functional box diagram illustrating a system for selecting objects from a user interface of an electronic device in accordance with an exemplary embodiment.

FIG. 2 is a schematic diagram illustrating a two dimensional coordinate system created by the system of FIG. 1.

FIG. 3 is a chart illustrating a two dimensional array created by the system of FIG. 1.

FIG. 4 is a flow chart illustrating a method for selecting objects from a user interface of an electronic device in accordance with another exemplary embodiment.

### DETAILED DESCRIPTION OF THE EMBODIMENTS

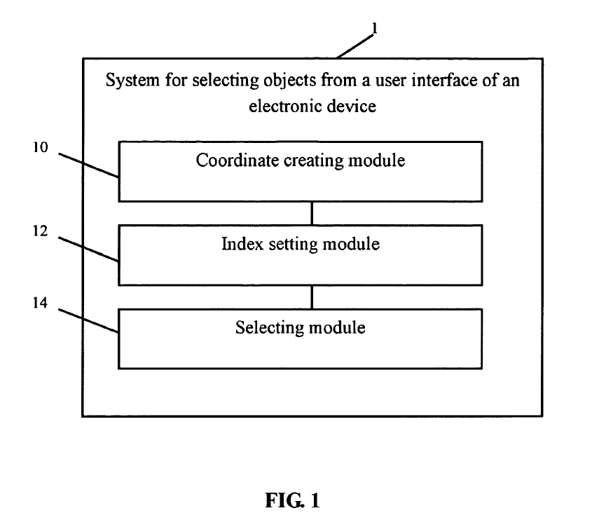

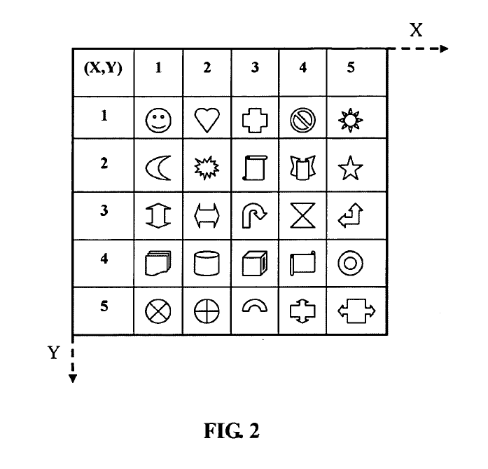

FIG. 1 is a functional box diagram illustrating a system for selecting objects from a user interface (UI) of an electronic device (hereinafter, “the system”) in accordance with an exemplary embodiment. The system 1 is installed and run in an electronic device (not shown in FIG. 1), which provides various UIs for invoking and/or operating different functions, such as editing a message, searching for a contact person, and so on. Each of the UIs may provide a number of objects that are selectable. The objects in the UI may include, but not limited to characters, numerals, symbols, and icons. For example, the characters such as “a,” “b,” “c,” etc; the numerals such as “1,” “2,” “3,” etc; the symbols such as “@, ” “!,” “?,” etc; and the icons such as, i.e., [symbol] as shown in FIG. 2.

The electronic device may be a computer, a mobile phone, a notebook, a PDA (Personal Digital Assistant), or other kinds of devices. In the exemplary embodiment, a mobile phone is taken as the electronic device, and the system 1 may be integrated in an operating system of the mobile phone, and configured for quickly and accurately selecting target objects from a number of objects in the UI. For example, the system 1 may select the target objects, i.e., the numerals, the symbols, the characters, and/or the icons displayed on the UI when the user inputs messages, memorandums, or other information under a text input mode.

The system 1 typically includes a coordinate creating module 10, an index setting module 12, and a selecting module 14.

The coordinate creating module 10 is configured for creating a two dimensional (2D) coordinate system to position each of the number of objects correspondingly in the UI, and acquiring a 2D coordinate value of each of the number of objects from the 2D coordinate system. As shown in FIG. 2, which is a schematic diagram illustrating the 2D coordinate system. Various icons are positioned in the 2D coordinate system, referencing a horizontal X axis and vertical Y axis. Each of the icons is assigned a corresponding 2D coordinate value, for example, a 2D coordinate value of the icon [symbol] as shown in FIG. 2 is (3, 4).

The index setting module 12 is configured for setting an index corresponding to each of the number of objects, and creating a 2D array to store each of the index. Each of the number of objects has a unique index, so that a target object may be selected from the number of objects in the UI according to the unique index of the target object.

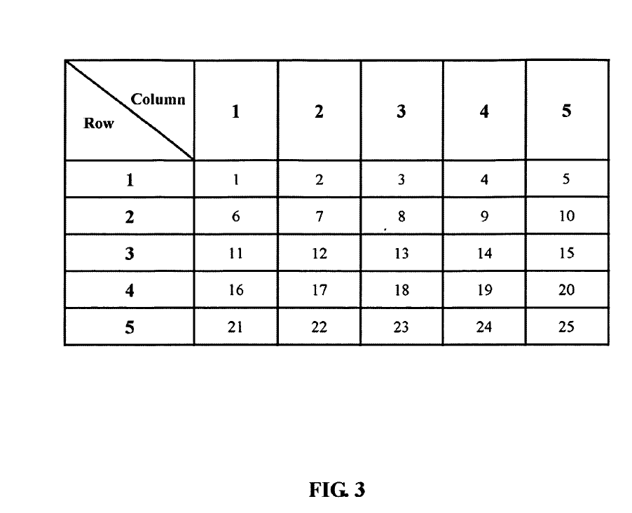

As shown in FIG. 3, which is a chart illustrating the 2D array that contains rows and columns. The indexes of the objects are stored in the 2D array. For example, an index of the icon [symbol] is “18,” which corresponds to the 4^{th} row and the 3^{rd} column of the 2D array.

The selecting module 14 is configured for displaying a coordinate input box (dialog box) in the UI for inputting a 2D coordinate value of the target object, in (X, Y) coordinate terms as shown at the top left corner of FIG. 2. The coordinate input box is in an editable mode when the user accesses the UI, and displays the coordinate currently receiving input with an underline. For example, (X, Y) represents that coordinate “X” is being input.

In the exemplary embodiment, the 2D coordinate value may be input by using a keypad/keyboard of the electronic device. In other embodiments, the 2D coordinate value also may be input by means such voice input.

The selecting module 14 is further configured for identifying an input 2D coordinate value of the target object received from the coordinate input box, confirming a position in the 2D array according to the input 2D coordinate value, acquiring a corresponding index from the 2D array according to the confirmed position, selecting and acquiring the target object form the UI according to the corresponding index. For example, if the input 2D coordinate value is (3, 4), the position is confirmed to be in the 4^{th} row and the 3^{rd} column of the 2D array according to the input 2D coordinate value, the index “18” is acquired according to the confirmed position, and then the target object having the unique index of “18,” such as the icon [symbol] is selected and/or invoked.

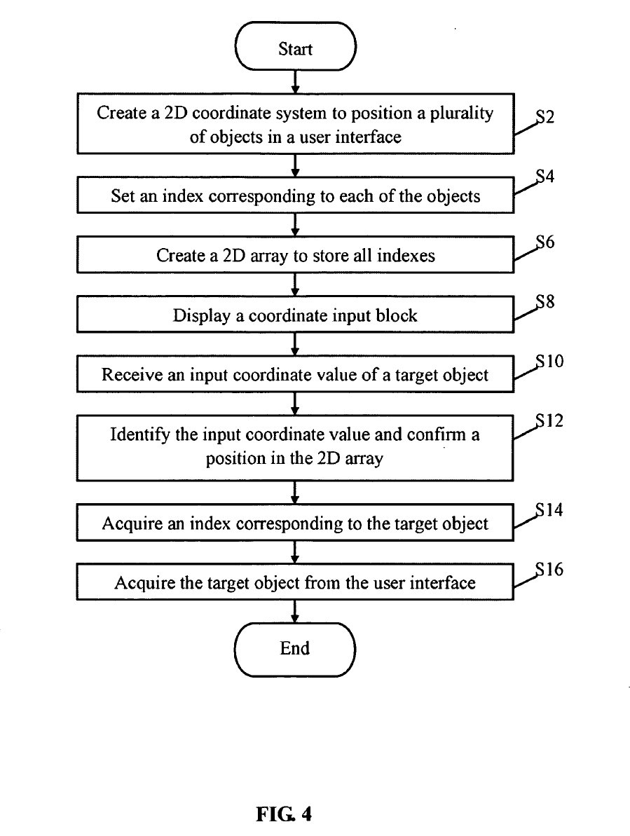

FIG. 4 is a flow chart illustrating a method for selecting objects from a UI of an electronic device in accordance with another exemplary embodiment. In step S2, the coordinate creating module 10 creates a 2D coordinate system to position each of the number of objects correspondingly, and acquiring a 2D coordinate value of each of the number of objects from the 2D coordinate system.

In step S4, the index setting module 12 sets an index corresponding to each of the number of objects respectively. Each of the number of objects has a unique index, so that a target object may be selected from the number of objects in the UI according to the unique index of the target object.

In step S6, the index setting module 12 creates a 2D array to store each of the index.

In step S8, the selecting module 14 displays a coordinate input box (dialog box) in the UI for inputting a 2D coordinate value of a target object, in (X, Y) coordinate terms as shown at the top left corner of FIG. 2.

In step S10, the selecting module 14 receives an input 2D coordinate value of the target object from the coordinate input box.

In step S12, the selecting module 14 identifies the input 2D coordinate value of the target object, and confirms a position in the 2D array according to the input 2D coordinate value. In step S14, the selecting module 14 acquires a corresponding index from the 2D array according to the confirmed position.

In step S16, the selecting module 14 selects and acquires the target object from the UI according to the corresponding index.

It should be emphasized that the above-described embodiments, particularly, any “exemplary” embodiments, are merely possible examples of implementations, and set forth for a clear understanding of the principles of the invention. Many variations and modifications may be made to the above-described exemplary embodiment(s) without departing substantially from the spirit and principles of the invention. All such modifications and variations are intended to be included herein within the scope of this disclosure and the above-described exemplary embodiment(s), and the present invention is protected by the following claims.

What is claimed is:

1. A system for selecting objects from a user interface of an electronic device, the system comprising:
a coordinate creating module configured for creating a two dimensional coordinate system to position a number of objects in the user interface, and acquiring a 2D coordinate value of each of the number of objects;
an index setting module configured for setting an index corresponding to each of the number of objects, and creating a two dimensional array to store all indexes; and
a selecting module configured for identifying an input 2D coordinate value of a target object, confirming a position in the two dimensional array according to the input 2D coordinate value, acquiring a corresponding index from the two dimensional array according to the confirmed position, and acquiring the target object from the user interface according to the corresponding index.

2. The system as claimed in claim 1, wherein the selecting module is further configured for displaying a coordinate input box in the user interface for inputting the 2D coordinate value of the target object.

3. The system as claimed in claim 1, wherein the 2D coordinate value is input by using a keyboard of the electronic device.

4. The system as claimed in claim 1, wherein the 2D coordinate value is input by means of voice input.

5. The system as claimed in claim 1, wherein each of the indexes uniquely corresponds to each of the number of objects.

6. A method for selecting objects from a user interface of an electronic device, the method comprising:
creating a two dimensional coordinate system to position a number of objects in the user interface;
acquiring a 2D coordinate value of each of the number of objects;
setting an index corresponding to each of the number of objects;
creating a two dimensional array to store all indexes;
identifying an input 2D coordinate value of a target object;
confirming a position in the two dimensional array according to the input 2D coordinate value;
acquiring a corresponding index from the two dimensional array according to the confirmed position; and
acquiring the target object from the user interface according to the corresponding index.

7. The method according to claim 6, further comprising:
displaying a coordinate input box in the user interface for inputting the 2D coordinate value of the target object; and
receiving the input 2D coordinate value of the target object from the coordinate input box.

8. The method according to claim 6, wherein the 2D coordinate value is input by using a keyboard of the electronic device.

9. The method according to claim 6, wherein the 2D coordinate value is input by means of voice input.

10. The method according to claim 6, wherein each of the indexes uniquely corresponds to each of the number of objects.
